(19) United States
(12) Patent Application Publication
(10) Pub. No.: US 2006/0056488 A1
(43) Pub. Date: Mar. 16, 2006

(54) Method and apparatus for measuring temperature with the use of an inductive sensor

(76) Inventors: Boris Surname, San Jose, CA (US); Yuri Vorobyev, San Carlos, CA (US); Leonid Velikov, San Carlos, CA (US); Matt Fauss, Santa Clara, CA (US)

Correspondence Address: Leonid Velikov, 1371 Greenbrier Rd., San Carlos, CA, 94070, US

(21) Appl. No.: 10/940,519

(22) Filed: Sep. 15, 2004

(51) Int. Cl. G01K 1/14; G01K 7/00; G01K 1/08; G01K 13/00

(52) U.S. Cl. 374/184; 374/141; 374/163

(57) ABSTRACT

The invention provides a method and apparatus for measuring temperature of a conductive film or coating on a non-conductive substrate or on a substrate having conductivity significantly lower than that of the film or coating. The temperature is measured with the use of an inductive sensor as at least one of electrical characteristics of the film or coating the relation of which with the temperature is known. The invention is intended for use in processes that involve heating of the conductive film or coating, e.g., annealing. The sensor is located on the side of the object-holding chuck opposite to the object but at a distance from the object that provides sensitivity of the sensor. A distinguishing feature of the invention is a shield formed from a layer of a dielectric-liquid that is permeable to electromagnetic waves but resistant to permeation of heat flow. This shield is arranged between the aforementioned conductive film or coating on a semiconductive substrate and the inductive sensor for shielding the sensor against influence of heat developed in the processing chamber. Preferably, the sensor is an inductive resonance-type sensor.

### CROSS REFERENCE TO RELATED APPLICATIONS

The present patent application is related to co-pending U.S. patent application Ser. No. 10/359,378 filed by B. Kesil, et al. on Feb. 7, 2003 and entitled “METHOD AND APPARATUS FOR MEASURING THICKNESS OF THIN FILMS WITH IMPROVED ACCURACY”, for which a Notice of Allowance has been granted.

### FEDERALLY SPONSORED RESEARCH

(Not applicable)

### SEQUENCE LISTING OF PROGRAM

(Not applicable)

### BACKGROUND OF THE INVENTION

1. Field of the Invention

The present invention relates to the field of metrology, more specifically, to a device and method for measuring temperatures of objects with the use of an inductive sensor. In particular, the invention may find use in the semiconductor industry for measuring temperature of conductive and semiconductive layers of semiconductor devices during temperature-controlled processes used in their manufacture or treatment.

2. Prior Art

Monitoring of various parameters and treatment conditions, e.g., of conductive layers of semiconductor wafers, is a critical issue in the manufacture of semiconductor devices.

Among various methods used for measuring parameters of semiconductor wavers at various stages of their manufacture, a method that employs inductive sensors is one of the most popular methods. This method is based on the principle that when an energized electromagnetic coil approaches the surface of a conductive or semiconductive layer, an electromagnetic field emitted by the coil generates an Eddy current in the aforementioned layer. This Eddy current, in turn, generates it own electromagnetic field that interacts with the coil of the sensor. Such interaction is known as inductive coupling or mutual inductance. Since the Eddy current generates in the sensor coil an electric current (which hereinafter will be referred to as an induced current) flowing in a direction opposite to the direction of main current of the electromagnetic coil of the sensor, the actual current of the sensor will decrease, and therefore one may consider this phenomenon as losses. The closer the sensor coil to the surface of the conductive or semiconductive layer, the greater the losses. Based on the above phenomenon, an inductive sensor may be used as a proximity or distance-measurement sensor. If a distance between the sensor coil and the surface of the conductive or semiconductive layer is fixed, than changes of the active current of the sensor coil will reflect changes in the surface resistance of the layer.

In case of thin conductive or semiconductive films, their surface resistance will to a great extent depend on the thickness of the film. Thus, by fixing the distance between the sensor coil and the surface of the film, one can measure the thickness of the film, provided that preliminary calibration procedure has been done.

Similarly, the above method can be used for measuring other characteristics of conductive and semiconductive layers or films that influence on conductivity through the aforementioned layers or films. Such characteristics may be comprised of concentration of impurities, grain structure of the layer or film material, local non-uniformities or defects, etc.

It is well known, however, that conductivity is a strong function of the object's temperature. Therefore, it becomes rather difficult to measure characteristics of the conductive or semiconductive layers or films when the process is accompanied by temperature variations. For example, when characteristics of a film are measured with temperature variations, e.g., during deposition of this film, it is difficult to determine what factor affects the characteristics, the temperature or increase in the thickness of the layer.

In accordance with the existing practice, the problem is solved by providing an additional sensor for measuring temperature variations and separating the role of the temperature from the thickness-increase effect. In any case, the correct measurement can be facilitated by using preliminarily obtained calibration data.

An attempt to solve the above problem is described, e.g., in U.K. Patent 2,187,844 issued on Sep. 16, 1987 to J. Charpentier. The patent describes a non-contacting, eddy current, measuring method for determining the thickness and temperature of a moving metal sheet, e.g., in a metal rolling operation. Two separate magnetic fields are generated by applying two voltages of differing frequencies to a primary winding on one side of the sheet to induce two voltages in an opposed secondary winding on the other side of the sheet. The generated voltages are used to determine calibration constants required to calculate the thickness and temperature of the moving sheet.

However, the above patent does not teach that change of the temperature may also influence the characteristics of the sensor coil itself. Heretofore, many attempts have been made for the solution of the last-mentioned problem. These attempts are reflected in many patents some of which are given as examples below. The proposed solutions can be roughly divided into two categories. The first category provides methods based on structural improvements of the inductive sensor.

For example, USSR Inventor's Certificate No. SU 1,394,912 issued on Aug. 27, 1995 describes a high-temperature conductor eddy-current sensor that includes a case, insulating frame, ferrite toroidal core, inductance coil, and a short-circuit current circuit made in the form of elongated coaxial cylinders separated by a layer of insulating material, and a sensitive element presenting a linear conductor connecting diametrically opposite points of corresponding cylinders on a working butt of the sensor. Expansion of the temperature range in operation of the sensor is provided due to removal of the inductance coil with the ferrite core from the zone of measurement. The proposed design of the converter also provides for protection of ferrite coil and inductance coil of the converter against corrosive action of the medium in the measurement zone. The effect of the aforementioned invention consists of spatially separating the sensor-object interaction zone and the zone of conversion. It is understood that if the elongated coaxial cylinders are made from a metal with poor thermal conductivity, e.g., stainless steel, the core with the coils can be displaced from the zone of temperature variations. A main disadvantage of the method and device of Patent SU No. 1,394,912 is that the effect of temperature is reduced due to decrease in sensitivity of the sensor.

Another example of a sensor belonging to the first category is disclosed in USSR Inventor's Certificate No. SU 1,104,406. The invention relates to a differential Eddy current sensor with temperature compensation. The sensor is comprised of a screening casing that contains three coils of different types, i.e., a field-generating coil, measuring coil, and a compensation coil, of which the compensation and measuring coils are arranged symmetrically with respect to the field-generating coil and are connected oppositely in series. The structural elements of the sensor are made from materials specially selected for stabilization of relative positions of the coils with respect to each other irrespective of temperature variations.

Unexamined Japanese Patent Application Publication (Kokai) H01-36736 issued on Feb. 7, 1989 to Ryo Masumoto, et al. describes an alloy for use in an Eddy-current type displacement sensor. The alloy is characterized by stability of electric resistance against temperature variations and has a low melting point due to the fact that Co, Fe and Au are alloyed in a non-oxidizing atmosphere under the prescribed conditions. The alloy consists of 0.01-10 wt. % Co, 0.01-8 wt. % Fe, and the balance Au. The alloy is cast and forged and is thereafter worked into a wire material or plate material to form the desired shape. It is then heated for 2 sec-100 hr at 200-800° C. in a non-oxidizing atmosphere, etc.

A main disadvantage of the sensor utilizing such an alloy is high resistivity that does not allow realization of sensitive elements suitable for use in sensors working under resonance conditions.

A main disadvantage of the devices and methods of any type belonging to the first category is that they do not compensate for changes in the inherent resistivity caused by temperature variation in the measuring coil itself. If an inductive coil contains a core, variations in the temperature of the core will also reflect on the sensitivity of the sensor. Another disadvantage is high cost of the alloy due to the use of gold.

Inductive sensors with temperature compensation that belong to the second category are based on the principles of electronic compensation of temperature variation. This group of methods and devices is presented by a large number of patents, the examples of some of which are given below.

Published U.S. Patent Application No. 2004/0075452 filed by K. Code on Apr. 22, 2004 discloses a circuit and method of temperature compensation. The circuit includes an evaluation unit for evaluating a measuring signal of the sensor. The sensor and the evaluation unit are interconnected via a connection cable. For the purpose of minimizing or preventing to the greatest extent temperature caused interferences, an additional compensation line is provided which compensates for the temperature of the connection cable. A corresponding method for compensating temperature is described.

U.S. Pat. No. 5,043,661 issued on Aug. 27, 1991 to P. Dubey describes an eddy current distance-measuring device with a temperature change compensation circuitry. Damping of a coil can be influenced by an object so that the high-frequency voltage at the coil depends on the distance of the object from the coil (L1). A constant DC current is superimposed on the high-frequency current through the coil, the DC voltage drop at the coil (L1), which corresponds to the DC resistance of the coil (L1), damping the coil (L1), being influenced by the temperature. The high-frequency excitation of the coil (L1) is controlled by the DC voltage drop in order to compensate for the influence of the temperature on the high-frequency voltage so that the high-frequency voltage depends solely on the distance (a). The high-frequency voltage, having a nonlinear correlation to the distance (a), is linearized in a nonlinear member with a semiconductor element with respect to the distance (a). In this connection, the effect of the temperature on the linearization is compensated for by means of a second semiconductor element.

U.S. Pat. No. 4,716,366 issued on Dec. 29, 1987 to S. Ando, et al. describes an Eddy current distance signal apparatus with temperature change compensation means. The measuring apparatus includes a multiplier connected to one secondary coil of a pair of secondary coils in an eddy current sensor. The secondary coil outputs are inputted to a differential amplifier, and the resulting difference is adjusted to be zero when an object the distance to which is to be measured is not present. Thereafter, the sensor is located within measuring distance of, e.g., a steel plate, and the output of the differential amplifier is combined by an amplifier circuit with an oscillator output supplying a current to the primary coil of the sensor. An eddy current distance signal output is thus obtained.

U.S. Pat. No. 4,893,079 issued on Jan. 9, 1990 to Thomas Kustra, et al. describes a method for measuring physical characteristics of an electrically conductive material by the use of eddy-current techniques and compensating measurement errors caused by changes in temperature. The aforementioned technique includes a switching arrangement connected between primary and reference coils of an eddy-current probe which allows the probe to be selectively connected between an eddy current output oscilloscope and a digital ohm-meter for measuring the resistances of the primary and reference coils substantially at the time of eddy current measurement. In this way, changes in resistance due to temperature effects can be completely taken into account in determining the true error in the eddy current measurement. The true error can consequently be converted into an equivalent eddy current measurement correction.

German Patent DE 3,606,878 issued to U. Klueppelberg on Sep. 10, 1987 describes a method for compensating for the temperature-dependent damping losses of the amplitude of resonance of a resonant oscillator circuit excited by a generator. In order to be able to compensate for the additional temperature-dependent losses such as eddy current losses of the coil winding and of the pot core, dielectric losses of the winding capacitance, residual losses in the ferrite of the pot core, hysteresis losses and losses due to the casting compound, added to the resistive copper losses, the rms loss resistance of the resonant circuit is used as a measure in order to create an equivalent resistance, corresponding to the rms loss resistance, in the form of a temperature sensor which is connected to the oscillator coil with good thermal conductivity and produces a damping or undamping of the amplitude of oscillation of the oscillator signal which is proportional to the temperature change.

It is understood that compensation of temperature variations should involve measurement of the temperatures and ranges of their variation. It is also understood that none of the above methods, even with possible modifications, is suitable for conditions at which temperature varies in a very wide range, e.g., between 0° C. to 300° C.

A smaller group of patents of a third category relates to methods and devices that are intended for measuring temperature on the objects with the use of inductive sensors.

For example, U.S. Pat. No. 4,675,057 issued on Jun. 23, 1987 to D. Novorsky, et al. describes a method and apparatus for heat treating quench-hardenable ferrous alloy workpieces utilizing periodic eddy current excitation and reflection to determine the in-line cooling rate from the critical temperature of the workpiece material and comparing the in-line cooling rate against a standard rate for establishing acceptance or rejection of the quenched workpiece. A disadvantage of the aforementioned invention is that the process and apparatus proposed by this invention are intended only for specific conditions that do not require strict stabilization of the sensor coil temperature. The only requirement of the process is calibration of the response of the coil to temperature variation. This condition may not be acceptable for other conditions, e.g., those described in Unexamined Japanese Patent Application Publication (hereinafter Kokai) JP S59-087330.

The purpose of aforementioned Kokai JP S59-087330 is to measure in a non-contact manner the temperature of a thick magnetic material in a wide temperature range with high precision, by detecting the change of an induced voltage of a secondary coil which is accompanied with the variance of temperature of an object to be measured, as a displacement of the frequency from the initial value at the current time. The output of a phase difference operator is applied to a lift-off differential compensating operator together with the output of an integrator. If the output of the integrator is not 0, the output of the operator is applied to a frequency converter after eliminating the variation of the induced voltage due to a change of lift-off, and this output is converted to a variation Δf of the frequency of a primary coil exciting current required for making the output of the operator of zero and is applied to a frequency-temperature converting operator and an oscillation frequency control circuit. The frequency variation Δf is converted in the operator and is outputted as a temperature variation. Consequently, since the change of the induced voltage of the secondary coil accompanied with the variance of temperature of the object to be measured is detected as a displacement from the frequency at the current time, an exciting frequency is set preliminarily to measure the temperature in a wide temperature range with a high precision.

In fact, the principle described in Kokai JP S59-087330 has been known to the applicants of the present Patent Application from U.S. Pat. No. 4,182,986 issued on Jan. 8, 1980. The aforementioned patent describes a test, control, and gauging method using locked oscillators. In other words, a pair of similar oscillators is coupled to each other such that when their natural resonant frequencies are close together they lock in and operate as synchronized oscillators over a predetermined range, which can be selected by control of circuit parameters. Within the range where the oscillators are locked to be equal in frequency, the phase angle between the frequency generated in each oscillator can be used as a measure of the influence on the resonant frequency of one oscillator relative to the other and where this influence is due to the parameters of an external test piece or the like influencing one oscillator, the measurement of phase angle is a measurement of a characteristic or parameter of the test piece. Accordingly, a go, no-go gauge can be operated by detecting phase differences of a predetermined magnitude using a threshold circuit or a direct indication of the phase angle can be calibrated in terms of some deviation in standard dimension or other feature of the test piece which influences the resonant frequency of one of the oscillators sufficiently to cause the synchronism between the two oscillators to be lost, each oscillator will operate at its own resonant frequency and this frequency difference can be detected to indicate that the test piece has deviated by more than a predetermined amount necessary to cause loss of synchronization. Various arrangements permit operation with static or dynamic parts, which are either discrete pieces or continuous sheet bar or wire stick and the like.

It should be noted that recently the inductive sensors find ever growing application in the semiconductor manufacture for measuring characteristics of super-thin films having thicknesses as small as hundreds of Angstroms, and variations of film thicknesses to be measured may be within the range of tens of Angstroms. Furthermore, temperature variations that may affect the film properties during the process may be as small as fractions of a degree of Celsius. None of the known inductive sensors described above becomes suitable for measuring such small thicknesses and temperature variations.

In an attempt to solve this problem, the applicants have developed a series of inductive sensors built on an entirely new principle, which has been named Resonance Sensor Technology (RST). The principle of RST is formulated in one of pending U.S. patent application Ser. No. 10/359,378 filed by B. Kesil, et al. on Feb. 7, 2003 for which a Notice of Allowance has been granted.

The principles of RST are based on the following features: 1) in contrast to the majority of known inductive sensors, the RST sensors operate on resonance conditions; 2) there exist several resonance conditions, and the RST sensors operate mainly under conditions of complete resonance; 3) under conditions of complete resonance, the Q-factor of the system “sensor-object” may be significantly higher than the Q-factor of a single inductive sensor.

Incorporation of the aforementioned three features into the structure of the measurement system results in significant improvement of sensitivity and repeatability of measurements and makes it possible to measure characteristics of the film in a wide ranges of thicknesses from hundreds of Angstroms to several tens of microns.

The above features cannot be implemented in the aforementioned known inductive sensor since, besides structural differences, the RST sensors operate in the range of frequencies significantly higher than operation frequencies of the known inductive sensors. The structural distinctions of the RST sensors include optimization of the sensor coil geometry and inherent capacitance of the oscillation circuit of the sensor. Another important feature involved in the measurement process with the use of an RST inductive sensor is the use of a capacitive coupling that is induced on the aforementioned high frequencies during the measurement process between the inductive coil of the sensor and the surface of the film being measured.

Experiments showed that in measuring characteristics of thin films associated with conductivity (in conductive films) and dielectric constant (in dielectric films under conditions of inherent resonance of the sensor) the RST sensors possess extremely high sensitivity and measurement accuracy.

However, the aforementioned unknown inductive sensors were intended for measuring exclusively characteristics of the films and coatings and it was unknown how could they be used for measuring temperature and small temperature deviations in the aforementioned films and coatings.

### BACKGROUND OF THE INVENTION

Objects and Advantages

It is an object of the present invention to provide an apparatus based on the use of an RST-type inductive sensor for measuring temperature and temperature deviations in thin films and coatings that possess conductivity. It is another object to provide a method for measuring temperature and temperature deviations in films that possess conductivity and in non-conductive films located in the vicinity of the measurement point with the use of the aforementioned apparatus. It is still another object to provide the apparatus and method of the aforementioned type wherein the coil of the inductive sensor is protected from the effect of the process temperature. A further object is to provide an apparatus of the aforementioned type that is characterized by high sensitivity in combination with high accuracy of measurement.

### SUMMARY

In a preferred embodiment, the invention provides an apparatus for measuring a temperature of a conductive film or coating on a non-conductive substrate or on a substrate having conductivity significantly lower than that of the conductive film or coating. The temperature is measured with the use of an inductive sensor as at least one of electrical characteristics of the film or coating the relation of which with the temperature is known. The method and apparatus of the invention are intended for use in a process that involves heating of said conductive film or coating, e.g., in annealing. The apparatus is comprised of a processing chamber with means for heating the object, a chuck made from a material permeable to electromagnetic waves, located in said processing chamber, and intended for holding the conductive film or coating on the substrate during the process, and an inductive sensor for measuring a temperature of the conductive film or coating on a semiconductive substrate during the process that involves heating. The inductive sensor is located on the side of the chuck opposite to the object but at a distance from the object that is sufficient for accurate measurement of the object's characteristics. The apparatus also contains data acquisition means that are connected to the inductive sensor for obtaining data that corresponds to the temperature being measured. A distinguishing feature of the apparatus is a shield formed from a layer of a dielectric-liquid that is permeable to electromagnetic waves but resistant to permeation of heat flow. This shield is arranged between the aforementioned conductive film or coating on a semiconductive substrate and the inductive sensor for shielding the sensor against influence of heat developed in the processing chamber. Preferably, the sensor is an inductive resonance-type sensor.

A method of the invention consists of arranging the inductive sensor on the side of the object holder opposite to the object at a distance that allows measuring of at least one characteristic of the object and protecting the inductive sensor from the effect of the processing-chamber heat flow by arranging a heat-shielding barrier in the form of a dielectric-liquid layer or flow between the object and the inductive sensor.

### DRAWINGS

Figures

FIG. 1 is a schematic view of the apparatus of the invention.

FIG. 2 is a partial cross-sectional view of the chuck according to another embodiment with a heat shield groove encircling an inductive sensor.

FIG. 3 is a fragmental view of an essential part of the apparatus of FIG. 1 that shows position and arrangement of the RST sensor coil and explains the principle of the sensor operation.

### REFERENCE NUMERALS

10—apparatus of the invention
20—processing chamber
20a
22 and 22′—chuck
23 and 23′—chuck body
24 and 24′—wafer-support portion of the chuck
26, 26′—sensor assembly
27 and 27′—dielectric-liquid barrier
28—inductive sensor
28a—inductive-sensor coil
28b—ferrite core
28b′—virtual ferrite core
28c—working end of the sensor
28R—virtual coil (mirror image relative to the coil 28a)
30, 32 and 30′, 32′—lead wires
33—cooler
33a—liquid supply channel
33b—liquid removal channel
34 and 34′—flat cavity for the dielectric liquid
36—thermocouple
38—controller
40—recess
D2—distance from the end inductive coil to the surface that supports the object
W—object
CF—conductive film or coating
S′—object supporting surface
d—diameter of the inductive sensor
h—height of the inductive sensor
O—geometrical center of the coil 28a
α—solid angle with the apex in point O
O1 and O2—points on the edges of the facing side of the virtual coil 28R
L—heating lamps

### DETAILED DESCRIPTION OF THE INVENTION

### Preferred Embodiment

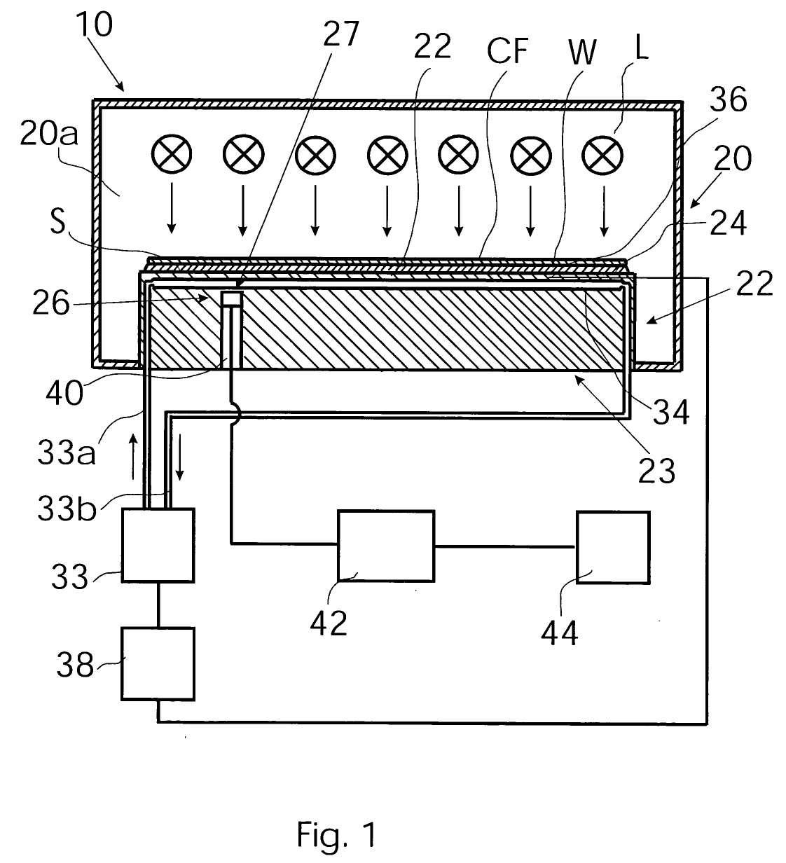

An apparatus of the invention is shown schematically in FIG. 1 which is a cross-sectional view of the apparatus. The apparatus 10 is comprised of a processing chamber 20 that may be, e.g., a vacuum chamber for treating semiconductor wafers, such as a semiconductor wafer W that consists of a semiconductor substrate S coated with a conductive film CF, e.g., with a thin copper film having a thickness from 100 Angstroms to few microns. As in a conventional wafer-processing chamber, the semiconductor wafer is held in a wafer chuck 22.

As shown in FIG. 1, the chuck 22 has a chuck body 23 made, e.g., of a material permeable to electromagnetic waves, e.g., of a ceramic, and a wafer support portion 24 also made from an electromagnetic-wave permeable non-conductive material or a material with conductivity significantly lower than that of the aforementioned conductive film or coating, e.g., from ceramic, plastic, glass, quartz, etc. The materials of the wafer support portion 24 and the chuck body 23 are selected with reference to the range of operation temperatures used in the processing chamber. For example, for high temperatures, the material of the wafer support portion 24 may comprise quartz or high-temperature ceramic, and for low temperatures the material may be comprised of a heat-resistant plastic.

The wafer-holding mechanism may be represented by any mechanism known in the art, e.g., a mechanism with gripping cams, a vacuum-holding mechanism with vacuum channels connected to a vacuum pump, or merely a mechanism where the wafer is self-supported on the surface of the chuck. These mechanisms are not shown in the drawings as they are beyond the scope of the invention and may be represented by any of hundred known structures.

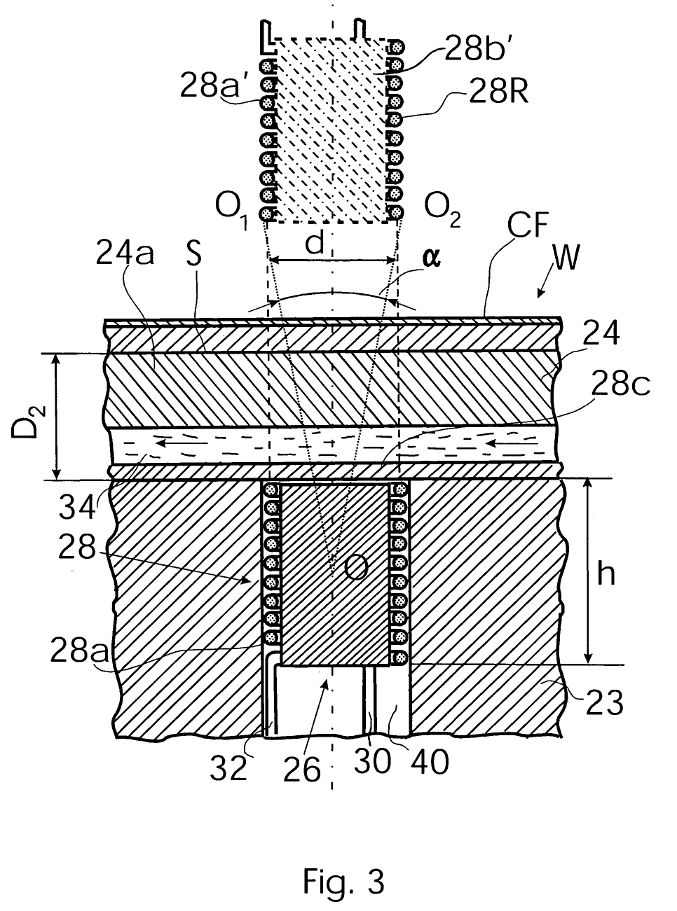

An essential part of the apparatus of the invention is an inductive resonance sensor assembly 26 shown in FIG. 3 that contains an RST-type sensor 28 with a sensor coil 28a of the type described in aforementioned U.S. patent application Ser. No. 10/359,378 of the same applicants. Reference numerals 30 and 32 designate lead wires that connect the sensor 28 with a source of power and a measurement instrument (not shown).

A distinguishing feature of the sensor assembly 26 is that in the apparatus 10 the sensor is located on the side of the chuck 22 opposite to the film or coating CF. It may even be located outside the processing chamber 20. In the illustrated embodiment, the sensor assembly 26 is installed in the chuck body 23 underneath the wafer-supporting portion 24 of the wafer-holding chuck 22 at a distance from the film or coating CF to be measured sufficient for providing acceptable sensitivity but excluding the effect of the heat of the processing chamber. Furthermore, the sensor assembly 26 is provided with means for shielding the RST-type sensor from the effect of the processing heat. In the embodiment of the invention shown in FIG. 1 these means are shown as a dielectric-liquid barrier 27 that is formed by providing a substantially flat cavity 34 in the chuck body 23, which is filled with a dielectric liquid. Such a liquid may be represented by water, deionized water, organic silicone oligomers or other organic liquids, such as Fomblins®, transformer oils, vacuum-pump oils, etc. The cavity may be sealed, or the liquid may circulate or pass through the cavity in a continuous flow. The state of the liquid (stationary or a flow) may depend on the heat-removal requirements. If necessary, the circulation liquid may pass through a cooler 33 (FIG. 1). Reference numerals 33a and 33b designate channels for the supply and removal of the liquid into and from the flat cavity 34.

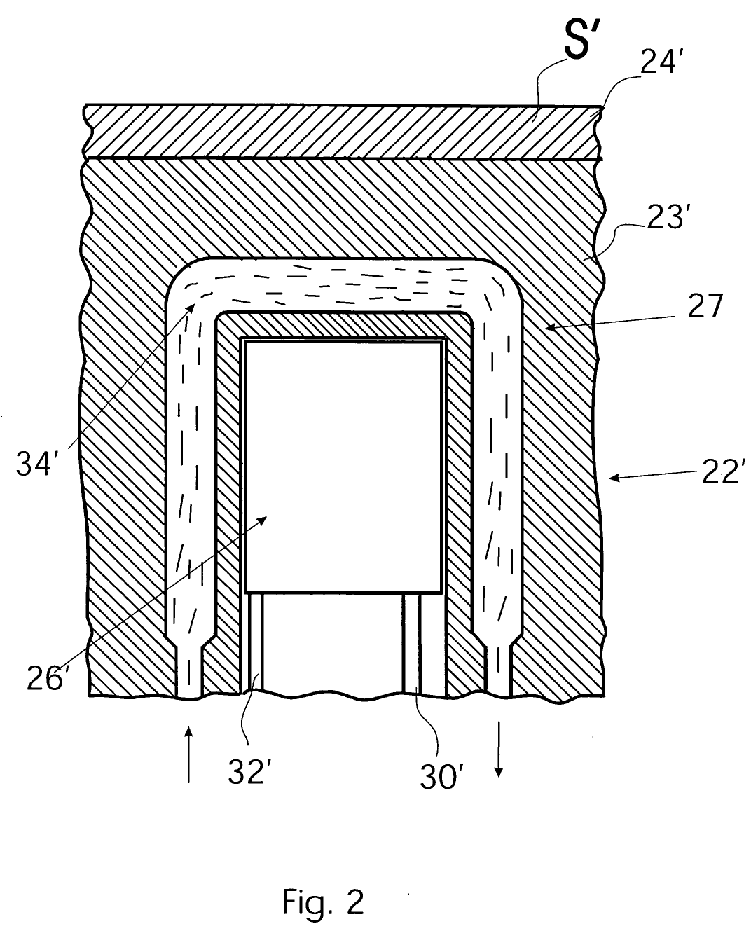

FIG. 2 shows an embodiment of the invention in which the cavity 34 is replaced by a cap-shaped groove 34′ that embraces the inductive sensor assembly 26′. Such an arrangement provide improved local protection of the sensor assembly 26′ from the processing heat. The remaining parts and elements of the embodiment of FIG. 2 are the same as those in the embodiment of FIG. 1. Therefore similar parts and elements of the embodiment of FIG. 2 are designated by the same reference numerals but with an addition of a prime. For example, 22′ designates a chuck, 23′ designates a chuck body, 24′ designates a wafer-support portion of the chuck 22′, etc.

Best results can be obtained with the use of a liquid that possesses high specific heat and low viscosity, since the width of the aforementioned cavity 34 may be as small as 1 mm. It is advantageous to make the width of the cavity as small as possible in order to shorten the distance D1 (FIG. 3) from the surface of the film or coating CF (FIG. 1) to be tested to the facing end of the sensor coil 28a (FIG. 3). If necessary, the RST-type sensor 28 may have a sensor coil 28a with a ferrite core 28b. Provision of the core 28b will assist in concentration of the magnetic flow and thus will allow improved sensitivity of the sensor 28a and installation of the sensor 28 at a distance from the object greater than for the sensor without the core.

It is important to note that for accuracy of measurements of the temperature variable in the coating or film CF, it is necessary to maintain the RST-type inductive sensor 28 at a permanent temperature. Therefore, the heat-removal liquid is intended only for creation of the dielectric barrier 27 against penetration of a heat flow to the sensor and not for cooling of the sensor 28. More specifically, the chuck body 23 may be provided with a thermocouple 36, which may respond to variations in the heat flow from the processing chamber 20 and is connected to the cooler 33 through a controller 38. In principle, the temperature of the inductive coil 28a may be different from the temperature on the wafer support portion 24 of the chuck 23 and from the temperature of the liquid. Irrespective of this, it is important to keep the sensor-coil temperature constant that can be achieved by providing steady operation conditions for heat flows variable during the operation.

The following description relates to the geometry and relative positions of the RST-type inductive coil 28a and the object being measured with reference to FIG. 3. As shown in this drawing, the inductive coil 28a is located in a recess 40 formed in the chuck body 23. Best results may be obtained with the inductive coil 28a having a ratio of diameter “d” to height “h” close to or greater than 1 (d/h≧1).

It is understood that the greater is the distance D2 from the working end 28c of the sensor coil 28a to the surface 24a, which supports the object W that contains the film or coating CF to be measured, the lower is sensitivity of the sensor 28. In fact, the aforementioned sensitivity depends on the part of the magnetic flow generated by the aforementioned virtual coil induced in the conductive coating or film CF that is detected by the sensor coil 28a. In FIG. 3, reference numeral 28R designates an inductive coil that conditionally may be considered as a virtual coil generated by the electromagnetic coil 28a of the sensor 28 in an infinite conductive object (not shown) that may conventionally replace the wafer W. The coil 28R is a mirror image of the coil 28a relative to the surface 24a but with the current flowing in the opposite direction. In other words, a distance between the actual coil 28a and the virtual coil 28R is equal to two D2 distances. If the actual coil 28a contains the core 28b, the virtual coil 28a′ should be also considered as having a virtual core 28b′ with the same magnetic parameters (e.g., a magnetic permeability μ) as the original core 28b.

It is understood that the virtual inductive coil 28R generates it own magnetic flow that is detected by the actual sensor 28, i.e., by the inductive coil 28a. In reality, the effect of the virtual coil 28R will change the resulting current that flows through the coil 28a. Such interaction between the actual coil 28a and the virtual coil 28R is interpreted in terms of mutual inductance, as it has been described in U.S. patent application Ser. No. 10/359,378 of the same applicants.

Furthermore, an inductive coupling between the sensor coil 28a and the virtual coil 28R is accompanied by a capacitive coupling. A role of the capacitive coupling increases on high frequencies of the resonance sensor 28. Both inductive and capacitive couplings grow with decrease of distance D2 (FIG. 3). Thus, it is understood that if one wants to reduce the effect of the temperature of the object W on the accuracy of the sensor 28, this can be done at the expense of the sensor's sensitivity.

The applicants have found a compromise between the aforementioned two contradictory factors, i.e., sensitivity and distance from the sensor to the object. Let us assume that point O (FIG. 3) is a geometrical center of the coil 28a. A solid angle α with the apex in point O and with the sides passing through the points O1 and O2 on the edges of the facing side of the virtual coil 28R may be construed as a numerical aperture of the coil sensor 28a. This parameter may be used as a characteristic for formalization of conditions at which the RST sensors of such a type as the RST sensor 28 can be used.

It has been found that if the sensor coil 28a with a ferrite core has the aforementioned numerical aperture that exceeds 0.1, the sensor will have acceptable sensitivity. The aforementioned condition can be expressed as follows:
α=[d/(2D2+h/2)]>0.1 (1)

If d=4 to 5 mm, h=4 to 5 mm, i.e., d/h≧1, the condition of formula (1) will allow position of the sensor at the depth of 6 to 9 mm from the surface 24a. It is clear that this distance provides sufficient room for the aforementioned dielectric-liquid heat barrier 27.

Condition (1) was obtained for inductive coils with a ferrite core, the geometry of which is shown in FIG. 3. The outer diameter of the core 28b is substantially the same as the inner diameter of the coil 28a of the sensor 28. Experiments showed that for inductive coils without the ferrite core 28b, condition (1) is transformed into the following:
α=[d/(2D2+h/2)]>0.5 (2)

Condition (2) shows that for providing satisfactory sensitivity, the coil 28a should be located closer to the object being measured. In reality, the distance 2D is reduced to a value not exceeding 3 mm.

It has been shown that the construction of the apparatus of the invention shown in FIGS. 1-3 makes it possible to measure characteristics of the conductive film or coating CF with the use of a sensor assembly 26 arranged on the side of the object W opposite to the working space 20a of processing chamber 20 (FIG. 1). Such an arrangement is an important feature of the apparatus for measuring characteristics of an object treated in a closed space under severe environmental conditions that not always allow location of the sensors or instruments in the processing chamber, e.g., because of a corrosive environment, high temperatures, high vacuum, or high pressure. In some cases location of a sensor, e.g., a proximity sensor, or instrument in the working space of the processing chamber may be not permissible as the presence of such an item may violate uniformity of treatment, etc.

A data acquisition and processing system 42 of the apparatus of the invention with a display 44 is the same as the one described in aforementioned U.S. patent application Ser. No. 10/359,378. Therefore this system is not shown in detail. The system 42 is connected to the output of the sensor 28.

Operation

The apparatus of the invention operates as described below.

Operation of the apparatus 10 will be considered, as an example, with reference to annealing of a copper layer CF on the surface of a semiconductor wafer W in the working space 20a of processing chamber 20 (FIG. 1). Such a process requires that the temperature of the copper layer CF be monitored during annealing.

First, the object, i.e., the semiconductor wafer W with a copper layer CF, is placed onto the support surface S of the wafer-holding chuck 22 and fixed therein with the copper layer CF facing up. The working chamber 20 is evacuated to a required level. Heat treatment of the copper layer CF may be conducted in a vacuum, or the space 20a may be filled with an inert gas.

Heating may be carried out, e.g., with the use of heating lamps L (FIG. 1), e.g., high-pressure Xenon lamps that provide heating to the annealing temperature, e.g., 400° C. When the lamps L are energized, the irradiated energy reaches the surface of the copper film CF and heats the film CF to the annealing temperature. In a certain period of time, the temperature regime in the working space 20a is stabilized, and the temperature of the copper film CF will be determined by the power of the lamps L. It is understood that by varying the power of the lamps it would be possible to adjust the temperature of the film CF.

It is known that conductivity of the film depends on temperature. Thus, by measuring resistance of the copper film CF with the use of the inductive RST-type sensor 28, it is possible to measure the film temperature. However, for accomplishing this task, it is necessary first to calibrate the sensor 28 in degrees of Celsius. Calibration is carried out by selecting a reference sample (not shown) of object to be measured, which in the illustrated case is a copper film of the same thickness as the film CF on a semiconductor substrate of the same type as the one that supports the film CF. The most accurate method of calibration is the one based on the use of known temperature values. Such conditions are created by heating the interior of the working space 20a of the processing chamber 20 to a temperature that corresponds to a predetermined fixed point of the temperature scale, e.g., to the melting point of ice (O° C.), melting points of gallium (29.8° C.), boiling point of water (100° C.), and melting points of indium (156.4° C.), bismuth (217.4° C.), tin (231.97° C.), lead (327.44° C.), zinc (419.5° C.), and, if necessary, of aluminum (660.24° C.). Calibration is conducted under thermostatic conditions, i.e., the temperature in the working space 20a is maintained uniform, and the rate of heating should be lower than the rate of equalization of temperature in the working space 20a.

The aforementioned reference samples are placed in the working space 20a into a position where they do not affect the operation of the RST inductive sensor 28. An actual sample W with the coating film CF to be calibrated is placed onto the surface S of the wafer-holding chuck 22. The temperature in the working space 20a is gradually increased for passing sequentially through all the aforementioned fixed points of the temperature scale. The aforementioned fixed points may be detected by means of a differential thermal analysis, which is a technique where two thermocouples are connected to a voltmeter. One thermocouple is placed in an inert material, while the other is placed in a sample of the material under study. As the temperature is increased, there will be a brief deflection of the voltmeter if the sample is undergoing a phase transition. This occurs because the input of heat will raise the temperature of the inert substance, but be incorporated as latent heat in the material changing phase.

An output signal of the inductive RST sensor 28 is registered for each fixed point of the temperature scale. Such a signal may be, e.g., in terms of amplitude of voltage, current, or power of resonance. Thus, a file of data that establishes relationship between the fixed-point temperatures and the output signals of the sensor 28 is obtained. This file may be presented in the form of a calibration curve or may be stored in a computer memory as a set of data, etc.

The above procedure is repeated for each specific material and thickness of the film. For example, for a copper film CF the procedure should be repeated for a plurality of film thicknesses that may present an interest for measurements.

The procedure may be repeated for films of different materials, and the accumulated data may be organized into a database or library.

Each time, when an object that is comprised of a film or coating on a substrate of the type corresponding to the data of the data base or data library has to be processed, e.g., annealed, the temperature regime of the process may be determined with the use of data retrieved from the data base or library.

### CONCLUSION, RAMIFICATION, AND SCOPE

Thus, it has been shown that the present invention provides an apparatus based on the use of an RST-type inductive sensor for measuring temperature and temperature deviations in thin films and coatings that possess conductivity. The invention also provides a method for measuring temperature and temperature deviations in films that possess conductivity and for indirectly measuring the temperature in non-conductive films located in the vicinity of the measurement point with the use of the aforementioned apparatus.

Although the invention has been shown and described with reference to specific embodiments, it is understood that these embodiments should not be construed as limiting the areas of application of the invention and that any changes and modifications are possible, provided that these changes and modifications do not depart from the scope of the attached patent claims. For examples, the method and apparatus are not limited by annealing, and the principle of the invention is applicable to any temperature-controlled process such as rapid thermal processing, temperature-controlled cleaning, surface oxidation, etching, wafer-bonding, temperature-controlled chemical supply, etc. Objects suitable for control of temperature during processing are not limited by conductive films such as copper, but may be comprised of a conductive film or coating from any metal, as well as objects made from a non-conductive materials that during treatment are located in close proximity to or maintained in contact with the conductive object so that the measured temperature of the aforementioned conductive object may be considered substantially equal to the temperature of the non-conductive object. The inductive coils themselves may have different shapes and structures. A temperature-controlled process may be carried out in vacuum, in the atmosphere, or under pressure.

We claim:

1. An apparatus for measuring a temperature of an object with the use of an inductive sensor in a process that involves heating of said object, said apparatus comprising:
a processing chamber with means for heating said object;
an object holder located in said processing chamber and intended for holding said object during said process, said object holder being made from a material permeable to electromagnetic waves;
an inductive sensor for measuring at least one temperature-sensitive characteristic of said object during said process that involves heating, said inductive sensor being located on the side of said object holder opposite to said object and at a distance therefrom that allows measurement of said at least one temperature-sensitive characteristic;
data acquisition means that is connected to said inductive sensor for obtaining data that corresponds to said at least one characteristic; and
means that protects said inductive sensor from the effect of said heating.

2. The apparatus of claim 1, wherein said means that protects said inductive sensor from the effect of said heating comprise sensor shielding means located between said object and said inductive sensor for shielding said inductive sensor against influence of said heating, said sensor shielding means being formed from a material permeable to electromagnetic waves but resistant to permeation of heat flows.

3. The apparatus of claim 2, wherein said sensor shielding means comprise a dielectric-liquid barrier that is formed by a layer of a dielectric liquid.

4. The apparatus of claim 3, wherein said layer of a dielectric liquid is selected from a stationary layer and a flow of a dielectric liquid.

5. The apparatus of claim 3, wherein said dielectric liquid is selected from the group consisting of water, deionized water, organic liquid, transformer oil, and a vacuum pump oil.

6. The apparatus of claim 1, wherein said inductive sensor is a resonance-type inductive sensor that has an inductive coil, said object being selected from the group consisting of a conductive coating and a conductive film on a non-conductive substrate, and a non-conductive coating and a non-conductive film located in close proximity to said conductive coating and said conductive film for indirect measurement of the temperature of said non-coating coating and said non-conductive film.

7. The apparatus of claim 2, wherein said inductive sensor is a resonance-type inductive sensor that has an inductive coil, said object being selected from the group consisting of a conductive coating and a conductive film on a non-conductive substrate, and a non-conductive coating and a non-conductive film located in close proximity to said conductive coating and said conductive film for indirect measurement of the temperature of said non-coating coating and said non-conductive film.

8. The apparatus of claim 3, wherein said inductive sensor is a resonance-type inductive sensor that has an inductive coil, said object being selected from the group consisting of a conductive coating and a conductive film on a non-conductive substrate, and a non-conductive coating and a non-conductive film located in close proximity to said conductive coating and said conductive film for indirect measurement of the temperature of said non-coating coating and said non-conductive film.

9. The apparatus of claim 4, wherein said inductive sensor is a resonance-type inductive sensor that has an inductive coil, said object being selected from the group consisting of a conductive coating and a conductive film on a non-conductive substrate, and a non-conductive coating and a non-conductive film located in close proximity to said conductive coating and said conductive film for indirect measurement of the temperature of said non-coating coating and said non-conductive film.

10. The apparatus of claim 5, wherein said inductive sensor is a resonance-type inductive sensor that has an inductive coil, said object being selected from the group consisting of a conductive coating and a conductive film on a non-conductive substrate, and a non-conductive coating and a non-conductive film located in close proximity to said conductive coating and said conductive film for indirect measurement of the temperature of said non-coating coating and said non-conductive film.

11. The apparatus of claim 4, wherein said flow of a dielectric liquid is a circulation flow and wherein said apparatus further comprises a temperature-measurement means for measuring said temperature in said processing chamber; a cooler, and a controller through which said temperature-measurement means are connected to said cooler for maintaining said inductive coil at a constant temperature.

12. The apparatus of claim 5, wherein said flow of a dielectric liquid is a circulation flow and wherein said apparatus further comprises a temperature-measurement means for measuring said temperature in said processing chamber; a cooler, and a controller through which said temperature-measurement means are connected to said cooler for maintaining said inductive coil at a constant temperature.

13. The apparatus of claim 6, wherein said inductive coil satisfies the following condition: α=[d/(2D2+h/2)]>0.5, where “d” is a diameter of said inductive coil, “h” is a height of said inductive coil, and “D2” is a distance from the end face of said inductive coil that faces said object to a surface that supports said object.

14. The apparatus of claim 7, wherein said inductive coil satisfies the following condition: α=[d/(2D2+h/2)]>0.5, where “d” is a diameter of said inductive coil, “h” is a height of said inductive coil, and “D2” is a distance from the end face of said inductive coil that faces said object to a surface that supports said object.

15. The apparatus of claim 8, wherein said inductive coil satisfies the following condition: α=[d/(2D2+h/2)]>0.5, where “d” is a diameter of said inductive coil, “h” is a height of said inductive coil, and “D2” is a distance from the end face of said inductive coil that faces said object to a surface that supports said object.

16. The apparatus of claim 9, wherein said inductive coil satisfies the following condition: α=[d/(2D2+h/2)]>0.5, where “d” is a diameter of said inductive coil, “h” is a height of said inductive coil, and “D2” is a distance from the end face of said inductive coil that faces said object to a surface that supports said object.

17. The apparatus of claim 10, wherein said inductive coil satisfies the following condition: α=[d/(2D2+h/2)]>0.5, where “d” is a diameter of said inductive coil, “h” is a height of said inductive coil, and “D2” is a distance from the end face of said inductive coil that faces said object to a surface that supports said object.

18. An apparatus for measuring a temperature of a conductive film or coating on a semiconductive substrate with the use of an inductive sensor in a process that involves heating of said conductive film or coating, said apparatus comprising:
a processing chamber with means for heating said object;
a chuck located in said processing chamber and intended for holding said conductive film or coating on a semiconductive substrate during said process, said chuck being made from a material permeable to electromagnetic waves;
an inductive sensor for measuring a temperature of said conductive film or coating on a semiconductive substrate during said process that involves heating, said inductive sensor being located on the side of said chuck opposite to said object;
data acquisition means that is connected to said inductive sensor for obtaining data that corresponds to said temperature; and
shielding means located between said conductive film or coating on a semiconductive substrate and said inductive sensor for shielding said inductive sensor against influence of said heating.

19. The apparatus of claim 18, wherein said chuck is made from a dielectric material, and said shielding means comprises a recess made in said chuck below said conductive film or coating on a semiconductive substrate and filled with a dielectric liquid that is penetrable to electromagnetic waves but resistant to the passage of heat flow, said chuck being provided with an object support portion that is made from a material selected from the group consisting of a non-conductive material and a material with conductivity detectably lower than conductivity of said conductive film or coating.

20. The apparatus of claim 19, wherein said dielectric liquid constantly flows through said recess.

21. The apparatus of claim 19, wherein said dielectric liquid is selected from the group consisting of water, deionized water, organic liquid, transformer oil, and a vacuum pump oil.

22. The apparatus of claim 20, wherein said dielectric liquid is selected from the group consisting of water, deionized water, organic liquid, transformer oil, and a vacuum pump oil.

23. The apparatus of claim 18, wherein said inductive sensor is a resonance-type inductive sensor selected from the group consisting of an inductive resonance sensor with a ferrite and without a ferrite core.

24. The apparatus of claim 19, wherein said inductive sensor is a resonance-type inductive sensor selected from the group consisting of an inductive resonance sensor with a ferrite and without a ferrite core.

25. The apparatus of claim 20, wherein said inductive sensor is a resonance-type inductive sensor selected from the group consisting of an inductive resonance sensor with a ferrite and without a ferrite core.

26. The apparatus of claim 21, wherein said inductive sensor is a resonance-type inductive sensor selected from the group consisting of an inductive resonance sensor with a ferrite core and without a ferrite core.

27. The apparatus of claim 22, wherein said inductive sensor is a resonance-type inductive sensor selected from the group consisting of an inductive resonance sensor with a ferrite core and without a ferrite core.

28. The apparatus of claim 4, wherein said a flow of a dielectric liquid is a circulation flow and wherein said apparatus further comprises a temperature-measurement means for measuring said temperature in said processing chamber; a cooler, and a controller through which said temperature-measurement means are connected to said cooler for maintaining said inductive coil at a constant temperature.

29. The apparatus of claim 18, wherein said a flow of a dielectric liquid is a circulation flow and wherein said apparatus further comprises a temperature-measurement means for measuring said temperature in said processing chamber; a cooler, and a controller through which said temperature-measurement means are connected to said cooler for maintaining said inductive coil at a constant temperature.

30. The apparatus of claim 20, wherein said inductive sensor is a resonance-type inductive sensor selected from the group consisting of an inductive resonance sensor with a ferrite core and with a ferrite core.

31. The apparatus of claim 23, wherein the following condition should be satisfied for said inductive coil without a ferrite core: α=[d/(2D2+h/2)]>0.5, where “d” is a diameter of said inductive coil, “h” is a height of said inductive coil, and “D2” is a distance from the end face of said inductive coil that faces said object to a surface that supports said semiconductor substrate.

32. The apparatus of claim 24, wherein the following condition should be satisfied for said inductive coil without a ferrite core: α=[d/(2D2+h/2)]>0.5, where “d” is a diameter of said inductive coil, “h” is a height of said inductive coil, and “D2” is a distance from the end face of said inductive coil that faces said object to a surface that supports said semiconductor substrate.

33. The apparatus of claim 25, wherein the following condition should be satisfied for said inductive coil without a ferrite core: α=[d/(2D2+h/2)]>0.5, where “d” is a diameter of said inductive coil, “h” is a height of said inductive coil, and “D2” is a distance from the end face of said inductive coil that faces said object to a surface that supports said semiconductor substrate.

34. The apparatus of claim 26, wherein the following condition should be satisfied for said inductive coil without ferrite core: α=[d/(2D2+h/2)]>0.5, where “d” is a diameter of said inductive coil, “h” is a height of said inductive coil, and “D2” is a distance from the end face of said inductive coil that faces said object to a surface that supports said semiconductor substrate.

35. The apparatus of claim 27, wherein the following condition should be satisfied for said inductive coil without ferrite core: α=[d/(2D2+h/2)]>0.5, where “d” is a diameter of said inductive coil, “h” is a height of said inductive coil, and “D2” is a distance from the end face of said inductive coil that faces said object to a surface that supports said semiconductor substrate.

36. The apparatus of claim 23, wherein the following condition should be satisfied for said inductive coil with a ferrite core: α=[d/(2D2+h/2)]>0.1, where “d” is a diameter of said inductive coil, “h” is a height of said inductive coil, and “D2” is a distance from the end face of said inductive coil that faces said object to a surface that supports said semiconductor substrate.

37. The apparatus of claim 24, wherein the following condition should be satisfied for said inductive coil with a ferrite core: α=[d/(2D2+h/2)]>0.1, where “d” is a diameter of said inductive coil, “h” is a height of said inductive coil, and “D2” is a distance from the end face of said inductive coil that faces said object to a surface that supports said semiconductor substrate.

38. The apparatus of claim 25, wherein the following condition should be satisfied for said inductive coil with a ferrite core: α=[d/(2D2+h/2)]>0.1, where “d” is a diameter of said inductive coil, “h” is a height of said inductive coil, and “D2” is a distance from the end face of said inductive coil that faces said object to a surface that supports said semiconductor substrate.

39. The apparatus of claim 26, wherein the following condition should be satisfied for said inductive coil with a ferrite core: α=[d/(2D2+h/2)]>0.1, where “d” is a diameter of said inductive coil, “h” is a height of said inductive coil, and “D2” is a distance from the end face of said inductive coil that faces said object to a surface that supports said semiconductor substrate.

40. The apparatus of claim 27, wherein the following condition should be satisfied for said inductive coil with a ferrite core: α=[d/(2D2+h/2)]>0.1, where “d” is a diameter of said inductive coil, “h” is a height of said inductive coil, and “D2” is a distance from the end face of said inductive coil that faces said object to a surface that supports said semiconductor substrate.

41. A method for measuring a temperature of an object with the use of an inductive sensor in a process that involves heating of said object, said method comprising:
providing an apparatus that comprises a processing chamber with means for heating said object, an object holder located in said processing chamber and intended for holding said object during said process, an inductive sensor for measuring at least one temperature-sensitive characteristic of said object during said process that involves heating, and data acquisition means that is connected to said inductive sensor for obtaining data that corresponds to said at least one characteristic;
arranging said inductive sensor on the side of said object holder opposite to said object at a distance that allows measuring of said at least one characteristic; and
protecting said inductive sensor from the effect of said heating by arranging heat-shielding means between said object and said inductive sensor.

42. The method of claim 41, further comprising the steps of:
obtaining a calibration data that shows relationships between said at least one characteristic of said object and said temperature obtained on a sample of said object with known values of said at least one characteristics at known temperatures;
measuring said at least one characteristic of said object with the use of said inductive sensor;
finding with the use of said calibration data a value of said temperature by comparing said at least one characteristic obtained by measurement with said calibration data; and
adjusting said temperature of said object at a required level while maintaining said inductive coil under conditions that protects said inductive coil from the effect of said temperature.

43. The method of claim 42, wherein said inductive sensor is a resonance-type inductive sensor that has an inductive coil, said object being selected from the group consisting of a conductive coating and a conductive film on a non-conductive substrate, and a non-conductive coating and a non-conductive film located in close proximity to said conductive coating and said conductive film for indirect measurement of the temperature of said non-coating coating and said non-conductive film.

44. The method of claim 43, characterized by forming said heat-shielding means in the form of a dielectric-liquid barrier formed by a layer of a dielectric liquid.

45. The method of claim 42, characterized by passing said dielectric liquid in the form of a flow.

46. The method of claim 42, wherein said dielectric liquid is selected from the group consisting of water, deionized water, organic liquid, transformer oil, and a vacuum pump oil.

47. The method of claim 43, wherein said dielectric liquid is selected from the group consisting of water, deionized water, organic liquid, transformer oil, and a vacuum pump oil.

48. The method of claim 43, wherein said at least one characteristic of said conductive film or coating is electrical resistivity.
